(19) United States
(12) Patent Application Publication
(10) Pub. No.: US 2010/0277716 A1
(43) Pub. Date: Nov. 4, 2010

(54) NON-CONTACT OPTICAL FLOW MEASUREMENTS

(75) Inventor: Michael Davis, Glastonbury, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: CiDRA Corporated Services Inc., Wallingford, CT (US)

(21) Appl. No.: 12/741,278

(22) PCT Filed: Nov. 10, 2008
(86) PCT No.: PCT/US08/83008

§ 371 Date: May 4, 2010

Related U.S. Application Data
(60) Provisional application No. 60/986,624, filed on Nov. 9, 2007.

(51) Int. Cl. G01P 3/36

(52) U.S. Cl. 356/28.5; 356/28

(57) ABSTRACT

A method and apparatus are provided for non-contact optical flow measurement in a pipe, the apparatus having one or more modules configured to sense light that is scattered off several points longitudinally along a wall of a pipe having a medium flowing therein and to provide a signal containing information about a deflection of the wall of the pipe that can be used to determine a parameter related to the medium flowing in the pipe, including a flow rate of the medium. The deflection in the pipe wall is caused by a turbulence induced pressure fluctuation which in turn induces a localized pipe wall deflection.

### CROSS-REFERENCE TO RELATED APPLICATIONS

This application claims benefit to provisional patent application Ser. No. 60/986,624, filed 9 Nov. 2007, which is hereby incorporated by reference in its entirety.

### BACKGROUND OF THE INVENTION

1. Field of the Invention

The field of the invention relates to measuring parameters of a medium flowing in a pipe; and more particularly related to non-contact optical flow measurement of such a medium.

2. Description of Related Art

In many industrial environments periodic measurements are required on a process fluid or medium flowing within a pipe. Measurements of certain parameters related to the fluid or medium flowing in the pipe ranging from a simple flow rate to more complex entrained air are desired at a variety of locations throughout a plant. The assignee of the present patent application has developed many known techniques for making such measurements, including by way of example, techniques disclosed in U.S. Pat. Nos. 7,430,924; 7,139,667; 6,732,575; 6,354,147; as well as techniques disclosed in patent application Ser. Nos. 10/875,858, filed Jun. 14, 2004 (CC-748); 11/487,184, filed Jul. 13, 2006 (CC-863); 11/494,833, filed Jul. 28, 2006 (CC-864); and 12/179,214, filed Jul. 24, 2008 (CC-931), which are all hereby incorporated by reference in their entirety.

Currently, permanent or portable meters are known in the art using these types of techniques that determine one or more of such parameters by measuring pipe wall strain caused by turbulence induced pressure fluctuations of the fluid or medium flowing in the pipe. The permanent or portable meters, perform very well in many applications where there is time and access to install a meter on the pipe. However, for applications such as quick plant surveying, preventive maintenance or problem diagnostics, it may be more desirable to have a quick portable tool that does not require the time or pipe access the known meters require.

### SUMMARY OF THE INVENTION

The present invention provides a new and unique method and apparatus for non-contact optical flow measurement in a pipe.

The apparatus features one or more modules configured to sense light that is scattered off several points longitudinally along a wall of a pipe having a medium flowing therein and to provide a signal containing information about a deflection of the wall of the pipe that can be used to determine a parameter related to the medium flowing in the pipe, including a flow rate of the medium. The deflection in the pipe wall is caused by a turbulence induced pressure fluctuation which in turn induces a localized pipe wall deflection.

The one or more modules may include an optical detector configured to sense the light that is scattered off the several points longitudinally along the wall of the pipe and to provide the signal containing information about the deflection of the wall of the pipe that can be used to determine the parameter related to the medium flowing in the pipe.

The apparatus may include an optical source, such as a laser, configured to provide the light that is scattered off the several points longitudinally along the wall of the pipe. The optical source may include either several optical sources configured to illuminate simultaneously the several points on the wall of the pipe, or a single optical source configured to scan between the several points.

The one or more modules may include a Michelson interferometer module configured to split light from an optical source, such as a laser, between a reference arm and a sensing arm, to reflect light from the sensing arm off the wall of the pipe, to reflect light from the reference arm off an internal reflector, such a mirror, to recombine the light reflected off the wall of the pipe and the light reflected off the internal reflector so as to cause an interference, to detect a change in the interference, and to determine the deflection of the wall of the pipe based on the change in the interference. The deflection in the wall of the pipe is directly proportional to the change in the interference. The Michelson interferometer module may include an optical detector configured to sense the light reflected off the wall of the pipe and the light reflected off the internal reflector. The apparatus may include an optical source, such as a laser, configured to provide the light that is scattered off the several points longitudinally along the wall of the pipe by scanning between the several points.

The one or more modules may include a laser speckle pattern interferometry module configured to illuminate simultaneously the several points on the wall of the pipe, to image light reflected back from the several points on the wall of the pipe, and to determine the deflection of the wall of the pipe based on an interference pattern produced by the light reflected back from the several points on the wall of the pipe. The laser speckle pattern interferometry module may include an array of optical detectors, each configured to receive the light reflected back from a specific point on the wall of the pipe.

The apparatus may include a high pass filter configured to filter out vibrations unrelated to turbulence induced pipe wall displacement, such as vibrations resulting from movement related to an optical source/detector unit having the apparatus arranged therein.

The apparatus may include reflective tape placed longitudinally on the wall of the pipe configured to provide high-reflectivity sensing points.

The apparatus may form part of a handheld unit for making flow measurements, or form part of a unit that is placed on the floor.

The present invention may also take the form of a method featuring sensing light that is scattered off several points longitudinally along a wall of a pipe having a medium flowing therein and providing a signal containing information about a deflection of the wall of the pipe that can be used to determine a parameter related to the medium flowing in the pipe, including a flow rate of the medium.

In effect, the present invention provides some new techniques for making flow measurements using non-contact optical methods along with known processing techniques.

### BRIEF DESCRIPTION OF THE DRAWING

The drawing includes the following Figures:

FIG. 1 is a diagram of a pipe having turbulence induced pressure fluctuations that may be sensed in conjunction with the present invention.

FIG. 2 is a diagram of an optical technique for sensing pipe wall displacement that may be used in conjunction with the present invention.

FIG. 3 is a diagram of an example of a Michelson interferometer and how it is used to determine displacement consistent with the present invention.

FIG. 4 is a diagram of an example of a laser speckle pattern interferometry that may be used to simultaneously illuminate several sensing locations on a pipe consistent with the present invention.

### DESCRIPTION OF BEST MODE OF THE INVENTION

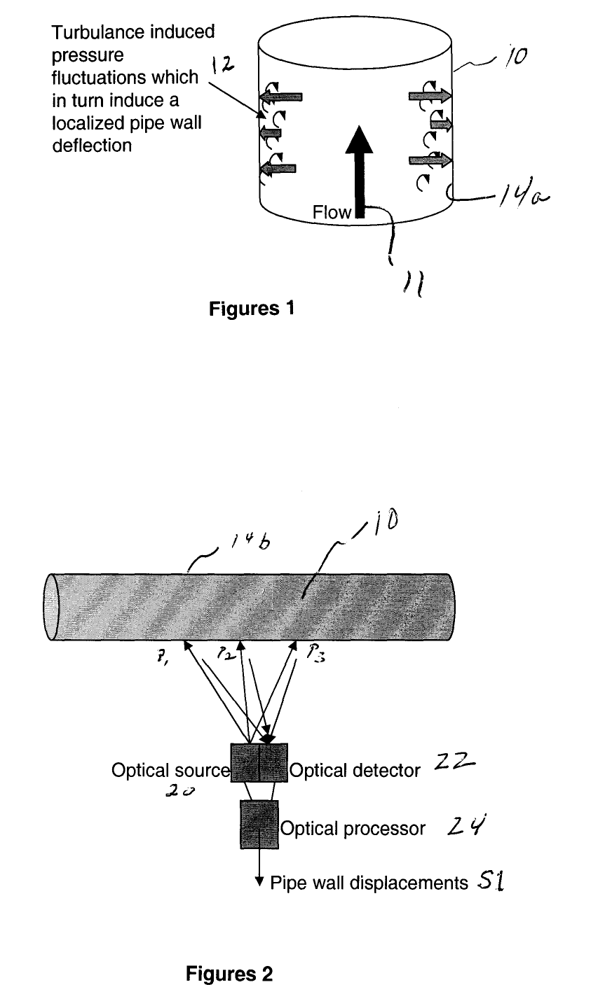

### FIG. 1: The Pipe 10

FIG. 1 shows a pipe 10 having a medium generally indicated by arrow 11 flowing therein with turbulence induced pressure fluctuations generally indicated as 12 that may be sensed in conjunction with the techniques of the present invention.

In two methods detailed, the measurement of a wall deflection of the pipe is determined, rather than the pipe wall strain as a known meter measures. Since the pressure fluctuations within the pipe 10 will cause pipe deflection and strain; both these methods will be able to give accurate measurements of the fluids within the pipe 10. Several different optical techniques can be used to give non-contact pipe deflections measurements from a remote area (i.e. the measurements can be made without touching the pipe and from a distance of ˜10 m away).

As a fluid flows through the pipe 10, it creates a turbulent layer when it comes in contact with a stationary pipe wall 14a inside the pipe 10. This turbulent fluid layer causes small-localized pressure fluctuations which strain and slightly displace on the outer pipe wall 14b, as shown in FIG. 1. The known meter utilizes strain sensors along the outside of the pipe wall 14b to detect the strain fluctuations in the pipe wall and will calculate a flow rate based on the sensed strain. Since the pipe wall also deflects slightly any measurement of the pipe wall deflection can also be used to determine the flow rate using a similar processing technique as the known strain based measurement.

As a person skilled in the art would appreciate, the expected localized pipe wall displacement depends heavily on the pipe material, pipe size, wall thickness, and fluid velocity; and the expected displacements are in the micron to sub micron range. To detect displacements this small, a number of optical detection techniques are known which can easily measure down to sub-nanometer displacements. Optical techniques also can be implemented using a non-contact approach providing the potential for an easy non-intrusive flow measurement.

### FIG. 2: The Basic Invention

FIG. 2 shows a general diagram of how this technique may work. In operation, the technique according to the present invention features sensing light that is scattered off several points longitudinally along the wall 14b of the pipe 10 having the medium flowing therein and providing a signal containing information about a pipe wall deflection or displacement of the wall 14b of the pipe 10 that can be used to determine a parameter related to the medium flowing in the pipe 10, including a flow rate of the medium. Essentially, as shown an optical source 20, such as a laser, is configured and used to illuminate several points P₁, P₂, P₃ longitudinally along the pipe wall 10. For each illumination point, an optical detector 22 senses the light that is scattered off the pipe wall 14b and passes a detected signal to an optical processor 24. This optical processor 24 is configured to use one of a variety of known techniques to determine the deflection or displacement and then provides or reports this displacement to a flow system via signal S1 containing information. The flow system is known in the art and the scope of the invention is not intended to be limited to any particular type or kind either now known or later developed in the future. As described below, in one embodiment several optical sources may be used to simultaneously illuminate the locations on the pipe, or in another embodiment a single source may be used that is rapidly scanned between the various locations.

Optical sources, detectors and processors are known in the art and the scope of the invention is not intended to be limited to any particular type or kind either now known or later developed in the future. By way of example, the functionality of an optical processor may be implemented in whole or in part using hardware, software, firmware, or a combination thereof. In a typical software implementation, it would include one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology either now known or later developed in the future.

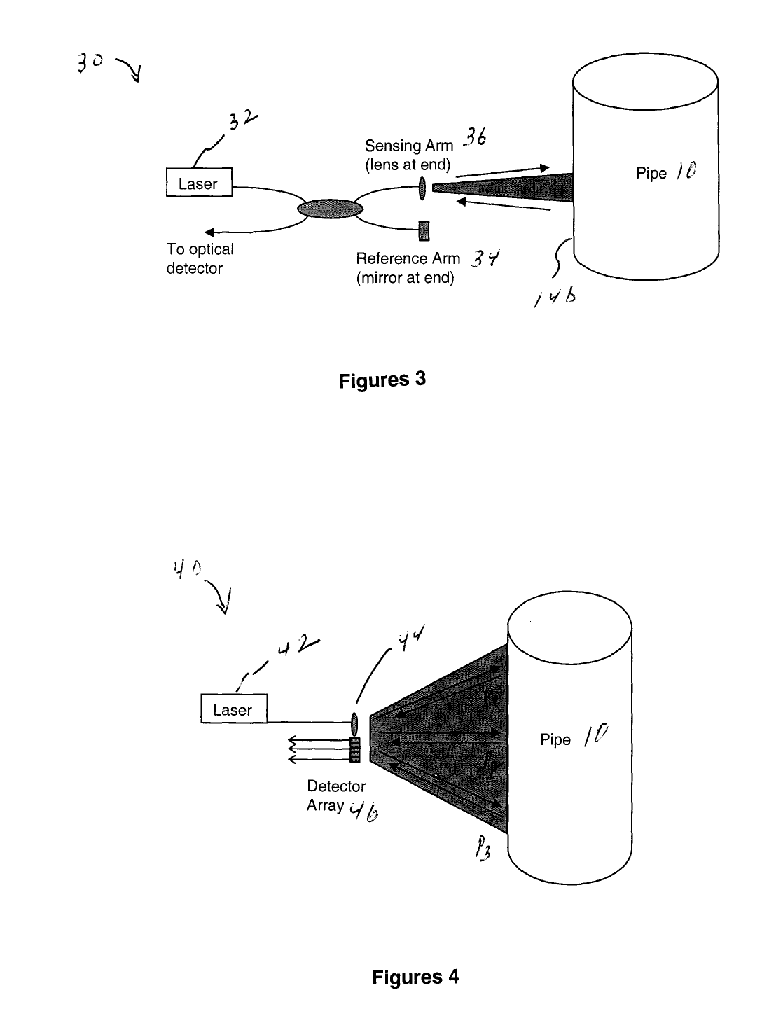

Examples of types of optical measurements may include Fabry-Perot and Michelson style interferometers shown and described in relation to FIG. 3 or laser speckle pattern interferometry shown and described in relation to FIG. 4.

### FIG. 3: The Michelson Interferometer

FIG. 3 shows an example of the Michelson interferometer and how it is configured and used to determine deflection or displacement.

Essentially, in a Michelson interferometer generally indicated as 30 the light from a laser 32 is split between a reference arm 34 and a sensing arm 36. The sensing arm light is reflected off the pipe wall 14b while the reference light is reflected off an internal mirror. The light that is reflected from the two arms is recombined and an interference occurs. This interference is detected by an optical detector, e.g. element 24 in FIG. 2, and monitored for overall intensity. As the pipe wall 14b deflects the sensing arm 36 effectively gets shorter or longer while the reference arm 34 always stays the same length. This change in length of the sensing arm 36 causes interference changes that are picked up by the optical detector 24 (FIG. 2) and are directly proportional to the sensing arm displacement. An optical processor, e.g. like element 24 in FIG. 2, is configured to use one of the variety of known techniques to determine the deflection or displacement and then provide or report this displacement or deflection information to the flow system via the signal S1 containing such information.

With the Michelson interferometer technique only one point or location P₁, P₂, P₃ on the pipe 10 would typically be illuminated at any one time, since if multiple reflections are detected it is will make the optical decoding more difficult. Therefore, in this configuration the laser source 32 would be quickly scanned between the multiple pipe sensing points or locations P₁, P₂, P₃. Such rapid scanning laser sources like 32 are known in the art, and the scope of the invention is not intended to be limited to any particular type or kind either now known or later developed in the future.

### FIG. 4: The Laser Speckle Pattern Interferometry

FIG. 4 shows an example of a laser speckle pattern interferometry generally indicated as 40, which is similar in many ways to the above-mentioned interferometer shown in FIG. 3; however it can be used to simultaneously illuminate several sensing location on the pipe.

In this embodiment, the laser 42 provides laser light that is spread by an optical element 44 about a large area of the pipe 10, which covers all the sensing points or locations P₁, P₂, P₃. The light that is reflected back from the pipe surface 14b is imaged onto an array of optical detectors 46, with each detector isolated configured to look at a specific or respective location P₁, P₂, P₃ on the pipe 10. This technique will then simultaneously give several points or locations P₁, P₂, P₃ where the interference pattern on the pipe 10 can be analyzed and a displacement value produced. An optical processor, e.g. like element 24 in FIG. 2, is configured to use one of the variety of known techniques to determine the deflection or displacement and then provide or report this displacement or deflection information to the flow system via the signal 51 containing such information.

Arrays like 46 are known in the art, and the scope of the invention is not intended to be limited to any particular type or kind either now known or later developed in the future.

### The Number of Displacement Points being Measured

The scope of the invention is not intended to be limited to the number displacement points being measured. The optical scanning techniques have the potential for the measurement of a large number of displacement points along the pipe. Since the known array processing algorithms for flow rate determination benefit by adding more measurements, it may be advantageous to measure as many points as possible.

### The High Pass Filter

Care must be taken on the implementation of these techniques since movement in the optical source/detector unit will also add into the displacement readings that are taken. However, for either a unit that is placed on the ground and aimed at the pipe 10, or a hand held unit, fluctuations that are produced by vibrations on the ground or by the person holding the unit will be of a very low frequency compared to the frequencies associated with the turbulent flow of the fluid or medium in the pipe 10. Therefore, a high pass filter can be utilized and configured to effectively filter out any movement except that caused by the turbulence induce induced pipe wall displacement. High pass optical filters are known in the art, and the scope of the invention is not intended to be limited to any particular type or kind either now known or later developed in the future.

### The Reflective Tape

Several variations on this concept can be envisioned. These include the use of reflective tape that may be placed longitudinally on the pipe to provide high-reflectivity sensing points for greater accuracy. Reflective tape is known in the art, and the scope of the invention is not intended to be limited to any particular type or kind either now known or later developed in the future.

### Alternative Embodiment

An additional interesting alternative is the use of thermal imagining. As the flow moves thought the pipe, small temperature fluctuations are often present in the flow. These fluctuations may only represent milli-degree type fluctuations on the surface of the pipe, however, a highly sensitive detector will be able to detect these small fluctuations and produce a signal that is comparable to the displacement or strain based signals that are used to detect one or more parameters of the medium flowing in the pipe related, including flow rate, in known products.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. Apparatus comprising:
one or more modules configured to sense light that is scattered off several points longitudinally along a wall of a pipe having a medium flowing therein and to provide a signal containing information about a deflection of the wall of the pipe that can be used to determine a parameter related to the medium flowing in the pipe, including a flow rate of the medium.

2. Apparatus according to claim 1, wherein the deflection in the wall of the pipe is caused by a turbulence induced pressure fluctuation which in turn induces a localized pipe wall deflection.

3. Apparatus according to claim 1, wherein the one or more modules comprises an optical detector configured to sense the light that is scattered off the several points longitudinally along the wall of the pipe and to provide the signal containing information about the deflection of the wall of the pipe that can be used to determine the parameter related to the medium flowing in the pipe.

4. Apparatus according to claim 1, wherein the apparatus comprises an optical source, such as a laser, configured to provide the light that is scattered off the several points longitudinally along the wall of the pipe.

5. Apparatus according to claim 4, wherein the optical source comprises either several optical sources configured to illuminate simultaneously the several points on the wall of the pipe, or a single optical source configured to scan between the several points.

6. Apparatus according to claim 1, wherein the one or more modules comprises a Michelson interferometer module configured to split light from an optical source, including a laser, between a reference arm and a sensing arm, to reflect light from the sensing arm off the wall of the pipe, to reflect light from the reference arm off an internal reflector, such a mirror, to recombine the light reflected off the wall of the pipe and the light reflected off the internal reflector so as to cause an interference, to detect a change in the interference, and to determine the deflection of the wall of the pipe based on the change in the interference.

7. Apparatus according to claim 6, wherein the deflection in the wall of the pipe is directly proportional to the change in the interference.

8. Apparatus according to claim 6, wherein the Michelson interferometer module comprises an optical detector configured to sense the light reflected off the wall of the pipe and the light reflected off the internal reflector.

9. Apparatus according to claim 6, wherein the apparatus comprises an optical source, such as a laser, configured to provide the light that is scattered off the several points longitudinally along the wall of the pipe by scanning between the several points.

10. Apparatus according to claim 1, wherein the one or more modules comprises a laser speckle pattern interferometry module configured to illuminate simultaneously the several points on the wall of the pipe, to image light reflected back from the several points on the wall of the pipe, and to determine the deflection of the wall of the pipe based on an interference pattern produced by the light reflected back from the several points on the wall of the pipe.

11. Apparatus according to claim 10, wherein the laser speckle pattern interferometry module comprises an array of optical detectors, each configured to receive the light reflected back from a specific point on the wall of the pipe.

12. Apparatus according to claim 1, wherein the apparatus comprises a high pass filter configured to filter out vibrations unrelated to turbulence induced pipe wall displacement, such as vibrations resulting from movement related to an optical source/detector unit having the apparatus arranged therein.

13. Apparatus according to claim 1, wherein the apparatus comprises reflective tape placed longitudinally on the wall of the pipe configured to provide high-reflectivity sensing points.

14. Apparatus according to claim 1, wherein the apparatus forms part of a handheld unit for making flow measurements, or forms part of a unit that is placed on the floor.

15. A method comprising:
sensing light that is scattered off several points longitudinally along a wall of a pipe having a medium flowing therein and providing a signal containing information about a deflection of the wall of the pipe that can be used to determine a parameter related to the medium flowing in the pipe, including a flow rate of the medium.

16. A method according to claim 15, wherein the deflection in the wall of the pipe is caused by a turbulence induced pressure fluctuation which in turn induces a localized pipe wall deflection.

17. A method according to claim 15, wherein the method comprises sensing with an optical detector the light that is scattered off the several points longitudinally along the wall of the pipe and to provide the signal containing information about the deflection of the wall of the pipe that can be used to determine the parameter related to the medium flowing in the pipe.

18. A method according to claim 15, wherein the method comprises providing with an optical source, such as a laser, the light that is scattered off the several points longitudinally along the wall of the pipe.

19. A method according to claim 18, wherein the optical source comprises either several optical sources configured to illuminate simultaneously the several points on the wall of the pipe, or a single optical source configured to scan between the several points.

20. A method according to claim 15, wherein the method comprises using a Michelson interferometer module configured to split light from an optical source, such as a laser, between a reference arm and a sensing arm, to reflect light from the sensing arm off the wall of the pipe, to reflect light from the reference arm off an internal reflector, such a mirror, to recombine the light reflected off the wall of the pipe and the light reflected off the internal reflector so as to cause an interference, to detect a change in the interference, and to determine the deflection of the wall of the pipe based on the change in the interference.

21. A method according to claim 20, wherein the deflection in the wall of the pipe is directly proportional to the change in the interference.

22. A method according to claim 20, wherein the Michelson interferometer module comprises an optical detector configured to sense the light reflected off the wall of the pipe and the light reflected off the internal reflector.

23. A method according to claim 20, wherein the method comprises providing with an optical source, such as a laser, the light that is scattered off the several points longitudinally along the wall of the pipe by scanning between the several points.

24. A method according to claim 15, wherein the method comprises using a laser speckle pattern interferometry module configured to illuminate simultaneously the several points on the wall of the pipe, to image light reflected back from the several points on the wall of the pipe, and to determine the deflection of the wall of the pipe based on an interference pattern produced by the light reflected back from the several points on the wall of the pipe.

25. A method according to claim 24, wherein the laser speckle pattern interferometry module comprises an array of optical detectors, each configured to receive the light reflected back from a specific point on the wall of the pipe.

26. A method according to claim 15, wherein the method comprises filtering out with a high pass filter vibrations unrelated to turbulence induced pipe wall displacement, such as vibrations resulting from movement related to an optical source/detector unit having the apparatus arranged therein.

27. A method according to claim 15, wherein the method comprises placing reflective tape longitudinally on the wall of the pipe so as to provide high-reflectivity sensing points.

28. A method according to claim 15, wherein the method comprising using the steps in a handheld unit for making flow measurements, or a unit that is placed on the floor.

29. A computer-readable storage medium having computer-executable components for performing a method for sensing light that is scattered off several points longitudinally along a wall of a pipe having a medium flowing therein and providing a signal containing information about a deflection of the wall of the pipe that can be used to determine a parameter related to the medium flowing in the pipe, including a flow rate of the medium, when run on a processor of a computer.
